(19) United States
(12) Patent Application Publication
(10) Pub. No.: US 2009/0248251 A1
(43) Pub. Date: Oct. 1, 2009

(54) HEADLIGHT CONTROL DEVICE

(75) Inventor: Toshio SUGIMOTO, Okazaki-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/409,648

(22) Filed: Mar. 24, 2009

(30) Foreign Application Priority Data
Mar. 25, 2008 (JP) 2008-078683

(51) Int. Cl. G06F 7/00; B62D 15/02

(52) U.S. Cl. 701/42

(57) ABSTRACT

A light control device is provided in which an operation is executed to acquire a detected result representing an own vehicle approaching an intersection (S140: YES), and an operation is executed to allow the orientation of the light axis of the headlight oriented in a turning-side to be moved to the turning direction (S230), Then, during a phase in which the orientation of the light axis of the headlight oriented in the turning-side is moved to the turning-side, if a steering angle takes a value equivalent to the turning behavior (S270; YES), an orientation of the headlight, placed on a side opposite to the turning-side, is moved to the turning-side (S280). This allows the orientation of the light axis of the headlight to be placed so as to allow the vehicle to maintain favorable visibility on a front area of the vehicle before the beginning of the turning behavior.

### CROSS REFERENCE TO RELATED APPLICATIONS

This application is based on Japanese Patent Application No. 2008-78683, filed on Mar. 25, 2008, the content of which is hereby incorporated by reference.

### BACKGROUND OF THE INVENTION

1. Technical Field of the Invention

The present invention relates to light control devices and, more particularly, to a light control device for controlling orientations of light axes of headlights mounted on a vehicle in front thereof.

2. Description of the Related Art

With the related art, there have been widely known light control devices that are arranged to move the orientation of the light axis of the headlight in a horizontal direction (left-to-right direction) of the vehicle. Patent Publication 1 (Japanese Patent Application Publication No. 7-186819) discloses a light control device arranged to maximize a displacement stroke (swivel angle) of the orientation of the light axis in the horizontal direction regardless of a steering angle when a vehicle speed lies at a low level and a turn signal is activated.

With the light control device of the related art, the swivel angle is maximized before a turning behavior begins. This enables a driver of a vehicle to easily recognize the pedestrian or the bicycle crossing the area inside the intersection.

Meanwhile, with the light control device of the related art, in order for the driver of the vehicle to further easily recognize a pedestrian or a bicycle crossing an area in an intersection, it may suffice for the swivel angle to be set to a maximal value that is large. However, like the light control device disclosed in Patent Publication 1, with the light control device having such a structure arranged to maximize the swivel angle before the turning behavior begins, increasing the maximal value of the swivel angle results in a drop in visibility in front of the vehicle before the beginning of the turning behavior. Therefore, there is an issue of a difficulty of setting the swivel angle in an increased maximal value.

### SUMMARY OF THE INVENTION

The present invention has been completed with a view to addressing the above issue and has an object to provide a light control device, having a function to move an orientation of a light axis of a headlight in a horizontal direction before the beginning of a turning behavior of a vehicle to maintain favorable visibility of a front area of the vehicle before the beginning of the turning behavior even if a swivel angle is set to an increased maximal value.

To achieve the above object, the present invention provides a light control device installed on a vehicle and having a function to control orientations of light axes of headlights mounted on left and right areas of the vehicle in front thereof, the light control device comprising: intersection detecting means for detecting if an own vehicle approaches an intersection of a road; intersection detected-result acquiring means for acquiring the result from the intersection detecting means; steering angle detecting means for detecting a steering angle of the own vehicle; steering angle acquiring means for acquiring the result from the steering angle detecting means; turning-behavior detecting means for detecting an indication of the own vehicle making a turn and a turning direction of the own vehicle regardless of the steering angle; turning-behavior indication acquiring means for acquiring the result from the turning-behavior detecting means; first swiveling means operative to allow an orientation of a turning-side headlight axis to be moved to the turning direction in response to the result of the intersection detected-result acquiring means, representing that the own vehicle approaches the intersection, and the result of turning-behavior indication acquiring means representing the indication of the own vehicle making the turn; and second swiveling means operative to allow an orientation of an opposite-to-turning-side headlight axis to be moved to the turning direction when the result, delivered from the steering angle acquiring means, reaches a steering angle indicating turning behavior during operation of the first swiveling means.

With the light control device according to the present invention, the headlight, facing the turning-side, illuminates a light in a direction to which the own vehicle is predicted to turn. This makes it possible for a driver of the own vehicle to easily recognize the presence or absence of a pedestrian or the like before the turning behavior is initiated.

Meanwhile, the other headlight, facing a direction opposite to the turning-side, illuminates an area placed in a turning-side after the turning behavior is initiated. That is, the other headlight, facing the direction opposite to the turning-side, illuminates an area placed in a traveling direction of the vehicle depending on the steering angle.

Accordingly, with the light control device of such a structure, even if the swivel angle is set to an increasing maximal value, the other headlight, facing the direction opposite to the turning-side, illuminates the area placed in the traveling direction at all times. This enables the driver to have favorable visibility on a front area of the vehicle before the turning behavior is initiated. In addition, the expression “steering angle indicating turning behavior” corresponds to a case in which a minimum steering angle, required for the turning behavior, is preliminarily determined and the result of the steering angle exceeds such a threshold value.

Meanwhile, with the light control device defined in one aspect of the present invention, it may be arranged in structure to allow the light axis of the headlight to be returned at random timing. Especially, such timing may be determined in various ways described below.

That is, the light control device may further comprise second swivel canceling means for canceling an operation of the second swiveling means and moving the orientation of the opposite-to-turning-side headlight axis to a predetermined reference position on a side opposite to the turning direction during the operation of the second swiveling means upon detecting a variation occurring in the steering angle of the own vehicle in a direction opposite to the turning direction.

With the light control device of such a structure, if the steering angle of the own vehicle begins shifting to a direction opposite to the turning-side, the orientation of the light axis of the headlight facing the direction opposite to the turning-side is returned from the turning-side-side maximal angle to a side opposite to the turning-side. This enables the vehicle to illuminate the light onto the area in the traveling direction of the vehicle even during the operation to restore the steering angle. Thus, the vehicle can maintain favorable visibility on a front area of the vehicle even during the operation to restore the steering angle.

Further, with the present invention, “the variation occurring in the steering angle of the own vehicle in the direction opposite to the turning direction” may be detected when the steering angle, acquired by the steering angle detecting means, is shifted toward the side opposite to the turning-side by even a small angle or when the steering angle is shifted toward the side opposite to the turning-side by a value exceeding a predetermined given angle. Further, with the present invention, “the reference position” may include a fixed position or a varying position that can vary depending on the steering angle.

With the light control device of such a structure, first swivel canceling means may be further preferably provided for canceling an operation of the first swiveling means and moving the orientation of the turning-side headlight axis to a predetermined reference position on a side opposite to the turning direction after the second swiveling means is operated when the steering angle, represented by the result acquired by the steering angle acquiring means, reaches a steering angle nonequivalent to the turning behavior.

With the light control device of such a structure, the orientation of the light axis of the headlight can be reliably returned to the reference position when the turning behavior is completed.

According to the present invention, further, the light control device may further include intersection entrance detecting means for detecting the own vehicle entering into a given area of the intersection where the own vehicle runs only when making a turn at the intersection for thereby providing a detected result, intersection entrance acquiring means for acquiring the result from the intersection entrance detecting means, and light axis raising means for causing the orientations of the light axes of the headlights to move upward when detecting the occurrence of the own vehicle entering into the given area in response to the result delivered from the intersection entrance detecting means.

With the light control device of such a structure, as the own vehicle approaches the intersection to make a turn, the orientation of the light axis of the headlight is moved upward. This enables the headlight to illuminate a pedestrian or a bicycle crossing the intersection when the vehicle turns.

With the light control device of such a structure, under a situation where the intersection is crossroads, the intersection may be preferably divided into four regions with two linear lines passing through centers of roads connected to the intersection, and the intersection entrance acquiring means may preferably detect the own vehicle entering into a right-side front region, acting as the given region, of the four regions.

With the light control device of such a structure, as the own vehicle enters the right-side front region during movement to make a right turn, the orientation of the light axis of the headlight is moved upward, thereby enabling the headlight to reliably illuminate the light to the pedestrian or the bicycle crossing the intersection. In addition, when the own vehicle enters the right-side front region, the steering angle of the own vehicle is equivalent to an angle corresponding to the steering effect and, thus, it is predicted that the orientations of the light axes of both the headlights are already moved to the turning-side-side maximum angle. Therefore, even if the orientations of the light axes of both the headlights are moved upward, the own vehicle has a low probability to dazzle an oncoming vehicle.

With the light control device of the structure mentioned above, in order to reliably prevent the headlights of the own vehicle from dazzling the oncoming vehicle, the headlight, in which the orientation of the light axis is not set to the turning-side-side maximum angle, may include inhibiting means for inhibiting the operation to move the orientation of the light axis upward.

### BRIEF DESCRIPTION OF THE DRAWINGS

FIG. 1 is a block diagram showing a general structure of a light control device of an embodiment according to the present invention.

FIG. 2 is a flow chart showing a first part of a swivel control routine for carrying out a swivel control operation.

FIG. 3 is a flow chart showing a second part of the swivel control routine to be consecutively executed with the swivel control routine shown in FIG. 2.

FIG. 4 is an overhead view of an intersection used for illustrating the relationship between a location of a vehicle, carrying out the swivel control operation shown in FIGS. 2 and 3, and an orientation of a light axis of a headlight.

### DETAILED DESCRIPTION OF PREFERRED EMBODIMENTS

Now, a light control device of one embodiment according to the present invention is described below with reference to various embodiments shown in the accompanying drawings. However, the present invention is construed not to be limited to such embodiments described below, and technical concepts of the present invention may be implemented in combination with other known technologies or other technologies having functions equivalent to such known technologies.

In the following description, it is to be understood that such terms as “left”, “right”, “front”, “upper”, “upward” and the like are words of convenience and are not to be construed as limiting terms.

As used herein, the term “turning-side headlight axis” refers to a light axis of one of the front headlights of a vehicle attempting to make a turn at an intersection of a road during traveling of the vehicle. The term “opposite-to-turning-side headlight axis” refers to a light axis of the other one of the front headlights on a side opposite to the front headlight oriented in the turning direction. The term “turning-side” refers to a side onto which the vehicle makes the turn. The term “turning-side maximum angle” refers to a maximum angle at which the orientation of the turning-side headlight axis is set.

The light control device of one embodiment according to the present invention will be described below with reference to the accompanying drawings.

[Structure of the Present Embodiment]

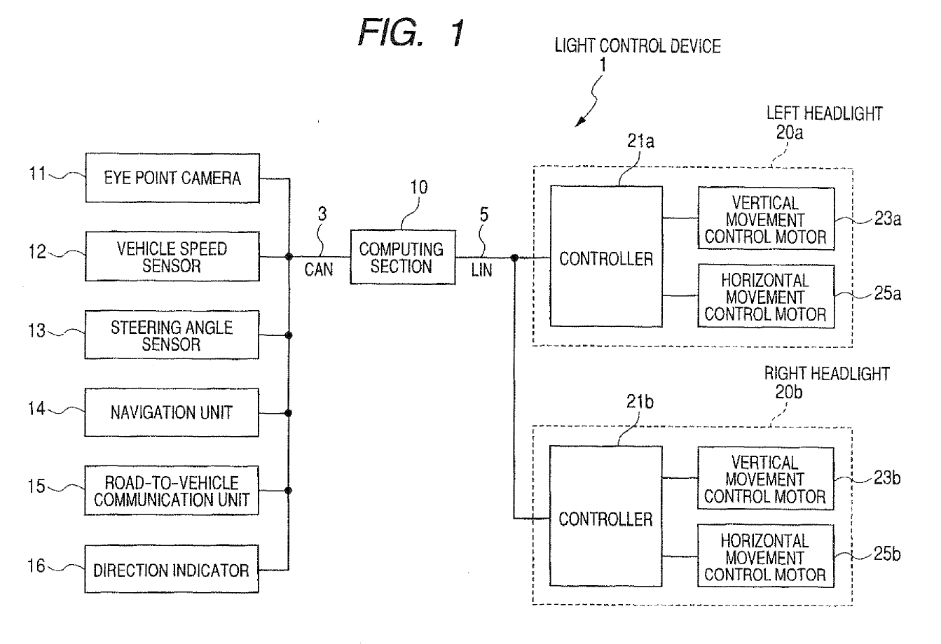

FIG. 1 is a block diagram showing a general structure of the light control device 1 to which the present invention is applied.

The light control device 1 is installed on a vehicle such as, for instance, a passenger car or the like. As shown in FIG. 1, the light control device 1 includes a computing section 10 having a CAN (Controller Area Network) communication line 3 through which communication is initiated with the CAN communication protocol, an eye point camera 1I (turning-behavior detecting means), a vehicle speed sensor 12, a steering angle sensor 13 (steering angle detecting means), a navigation unit 14 (intersection detecting means and intersection entrance detecting means), a road-to-vehicle communication unit 15, and a direction indicator 16. In addition, the computing section 10 is also connected to a LIN (Local Interconnect Network) communication line 6, permitting communication to be initiated with the LIN communication protocol, which in turn is connected to headlights 20a and 20b.

The eye point camera 11 is installed in a vehicle compartment to an image of a driver's face and internally includes a processor (not shown) that detects a driver's viewing direction in response to the image. In addition, the eye point camera 11 delivers the detected driver's viewing direction to the computing section 10 via the CAN communication line 3.

The vehicle speed sensor 12 is a known vehicle speed sensor that detects the vehicle speed (a traveling speed of the vehicle) to provide a vehicle speed output.

The steering angle sensor 13 is structured as a known sensor that detects a steering angular displacement of a steering wheel for steering the vehicle to provide a steering angular displacement (steering angle) output, which in turn is delivered through the CAN communication line 3 to the computing section 10.

The navigation unit 14 incorporates therein a known GPS (Global Positioning System) receiver that receives data on the current location of the own. The navigation unit 14 stores therein map data, in which latitude/longitude information are correlated with each other, and is arranged to cause map data, related to the current location of the own vehicle, to be displayed on a display together with the current location of the own vehicle.

Further, the navigation unit 14 delivers data to other equipment on request through the CAN communication line 3. In particular, upon receipt of a request from the computing section 10 for positional information of the own vehicle (at step S110 described below) during the execution of a swivel control operation, the navigation unit 14 delivers positional information to the computing section 10. The positional information includes: information as to whether the own vehicle is running in an urban area; and other information as to whether the own vehicle is running in an intersection area (such as, for instance, a region distanced from a center of the intersection by a distance of 50 m or less).

The road-to-vehicle communication unit 15 is an on-vehicle device that acquires information transmitted from a roadside unit adapted to provide information required for the running of the own vehicle as represented by a known beacon. The road-to-vehicle communication unit 15 is also operative to receive information related to a position at which the roadside unit is located to transmit received information to the computing section 10.

The direction indicator 16 is a known unit for providing information to the outside of the own vehicle on a traveling direction of the own vehicle and operative to transmit an operating state (i.e., information as to which of left and right direction indicators is under operation) of this unit to the computing section 10.

The computing section 10 is comprised of a known microcomputer including a CPU, ROM and RAM, etc. The computing section 10 receives various data delivered from various sensors (including the vehicle speed sensor 12 and the steering angle sensor 13) and various units (such as the eye point camera 11, the navigation unit 14, the road-to-vehicle communication units 15 and the direction indicator 16) via the CAN communication line 3. Depending on various data received, the computing section 10 executes operations to determine an angle (an illumination angle) at which light axes of lamps (not shown) (hereinafter merely referred to as “light axes”) of the headlights 20a and 20b.

Then, the computing section 10 transmits a control command, indicative of an illumination angle being specified, to the headlights 20a and 20b via the LIN communication line 5 so as to allow an actual light axis to be directed at an illumination angle being determined. In addition, examples of information on the illumination angle contained in the control command may preferably include angular information in a vertical direction (a fore and aft direction with respect to a traveling direction of the vehicle) and another angular information in a horizontal direction (a transverse direction with respect to the traveling direction of the vehicle) perpendicular to the vertical direction mentioned above.

Further, the illumination angle, determined with the computing section 10, represents a value indicating an angular difference between a reference angle, lying at a preset angle (such as, for instance, an angle parallel to a road surface in terms of the vertical direction and aligned on a frontal direction in the traveling direction of the vehicle in terms of the horizontal direction), and an angle of illumination light.

Here, like a known vehicle, the headlights 20a and 20b are mounted on the vehicle in two left and right positions at front areas of the vehicle. The computing section 10 outputs the control command to each of these headlights 20a and 20b. That is, the computing section 10 may take the form of one arrangement in which the control command, related to the light axes, is transmitted to a communication terminal composed of one of the headlights 20a and 20b. In another arrangement, the control command is transmitted to both of the headlights 20a and 20b.

Structure for lighting up the lamps (not shown) for the headlights 20a and 20b are omitted from the general structure of the present embodiment.

As shown in FIG. 1, the headlights 20a and 20b include controllers 21a and 21b, vertical movement control motors 23a and 23b, and horizontal movement control motors 25a and 25b, respectively. In addition, driving the vertical movement control motors 23a and 23b allows the light axes of the lamps to be moved in vertical directions, respectively.

Moreover, driving the horizontal movement control motors 25a and 25b allows the light axes of the lamps to be moved in horizontal directions, respectively. In addition, the various motors 23a, 23b, 25a and 25b may preferably include, for instance, stepping motors, respectively.

Each of the controllers 21a and 21b includes a known microcomputer including a CPU, ROMs and RAMs, etc. Upon receipt of the control commands delivered from the computing section 10, the vertical movement control motor 23 and the horizontal movement control motor 25 are driven. That is, the controllers 21a and 21b operate to compute an angular difference between an angle of the current light axis relative to the reference angle and an illumination angle involved in the control command in response to information on the illumination angle contained in the control command delivered from the computing section 10. Then, the controllers 21a and 21b transmit control signals to the various motors 23a, 23b, 25a and 25b such that the angular difference is zeroed. Due to such operations, the angle of the actual light axis is altered to meet the control command delivered from the computing section 10.

[Operation of Light Control Device of the Present Embodiment]

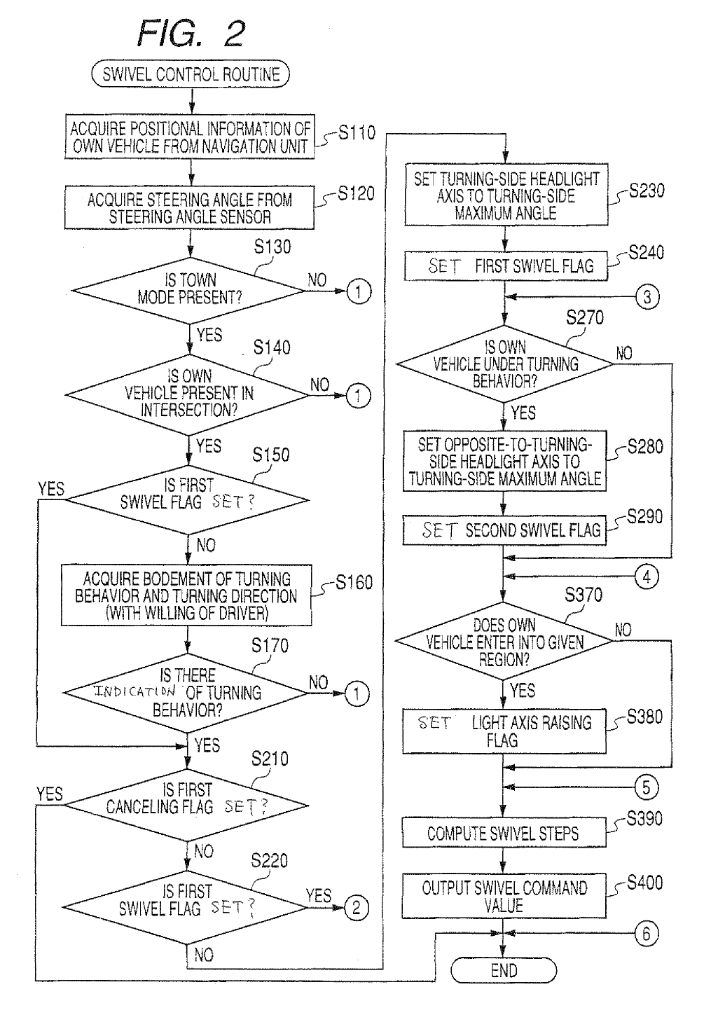

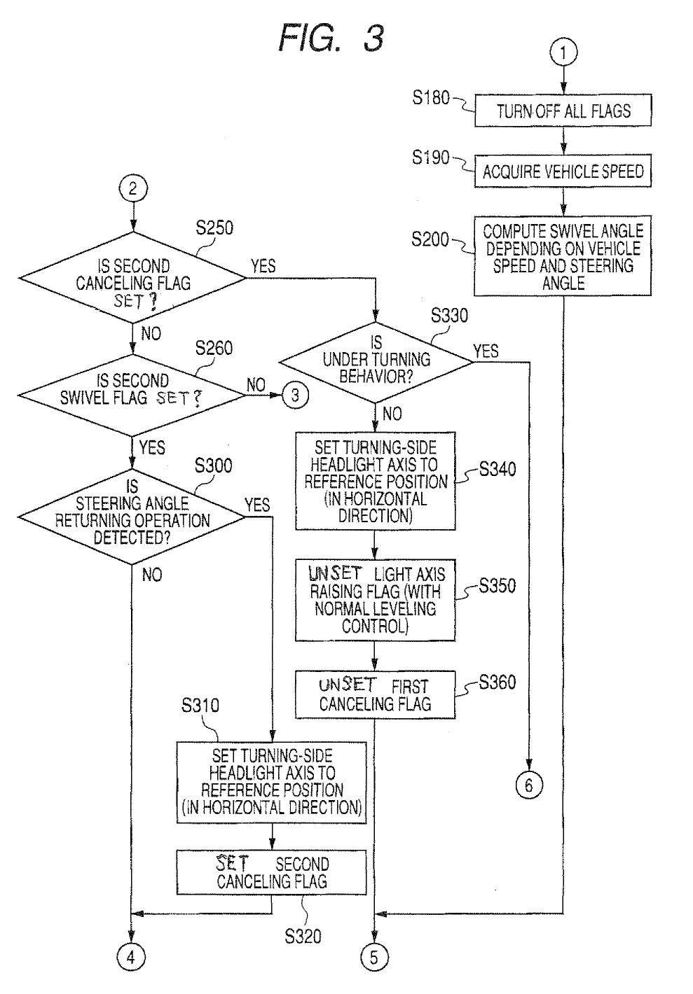

With the light control device 1 of the present embodiment, the orientation of the light axis of the headlight is controlled in a manner described below with reference to FIGS. 2 and 3. In the following description, however, the operation of the light control device 1 will be described below with reference to only a case of shifting the orientation of the light axis of the headlight in a horizontal direction and description of another case of shifting the orientation of the light axis of the headlight in the vertical direction for normal operation will be omitted herein.

When shifting the orientation of the light axis of the head light, an inclination of the vehicle along the fore and aft direction thereof is detected based on a detected result provided by a vehicle height sensor (not shown) or the like to allow known operation to be executed depending on such a detected result for computing an angle of the light axis.

FIGS. 2 and 3 are flow charts showing a swivel control routine to be executed with the computing section 10 for shifting the orientation of the light axis of the head light in the horizontal direction.

The swivel control routine is an operation started up for each cycle that is predetermined. That is, the swivel control routine is executed to shift orientations of light axes of headlights in horizontal directions independently from each other on left and right sides of the vehicle in accordance with a location of the vehicle and the presence or absence of an indication of turning behavior. In executing the swivel control routine, a series of operations are executed while making a record of a turning state upon using a plurality of flags (a first swivel flag, a second swivel flag, a first canceling flag, a second canceling flag and a light axis raising flag) allocated to given areas of the RAM incorporated in the computing section 10.

More particularly, the first swivel flag is placed in a turn-on state when a turning-side headlight axis (i.e., a light axis of the right headlight 20b of the vehicle during the movement thereof while making a right turn) is preset to shift to a turning-side maximum angle. In addition, the second swivel flag is placed in a set state when an opposite-to-turning-side headlight axis (i.e., a light axis of the left headlight 20a of the vehicle when making the right turn) is preset to shift to the turning-side maximum angle.

Next, the first canceling flag is placed in a turn-on state when turning motion is completed and the second canceling flag is placed in a turn-on state when the steering angle begins to be returned during a midcourse of the turning motion. Moreover, the light axis raising flag is placed in a turn-on state when the light axis is determined that the light axis is oriented further upward than that achieved in a usual mode.

In particular, in executing the swivel control routine, first, at step S110 corresponding to intersection detected-result acquiring means and intersection entrance acquiring means, position information is acquired from the navigation unit 14. Also, at step S120 corresponding to steering angle acquiring means, information on the steering angle is acquired. At succeeding step S130, a query is made as to whether the light control device 1 executes a control mode in a town mode (i.e., an urban cruising mode).

Here, the computing section 10 is arranged such that when the own vehicle is running in an urban area, the control mode is set to the town mode. Therefore, a variation occurs in the answer to the query as to whether the own vehicle is placed in the town mode depending on whether the own vehicle is running in the urban area.

If the answer to step S130 is no, i.e., if the control mode of the light control device 1 is not in the town mode, then, a series of operations (for normal swivel control) subsequent to step S180 are executed. Further, if the control mode of the light control device 1 is placed in the town mode (S130: YES), then, at step S140 corresponding to first swiveling means, a query is made as to whether the own vehicle is running in the intersection area.

If the own vehicle is not in the intersection area (S130: NO), then, the series of operations (for normal swivel control) subsequent to step S180 are executed. In addition, if the own vehicle is running in the intersection area (S140: YES), then, a query is made as to whether the first swivel flag is turned on (S150).

If the first swivel flag is placed in the turn-off state (S150: NO), then, at step S160 corresponding to turning-behavior indication acquiring means, an operation is executed to acquire information on the own vehicle with an indication of making a turn and a turning-side on this occasion. Upon receipt of such information, at step S170 corresponding to the first swiveling means, an operation is executed to make a query as to whether the own vehicle has the indication of making the turn. Here, the existence and nonexistence of the “indication of turning behavior” is determined upon detecting if the driver has a willing to make the turn without using the result of the steering angle sensor 13.

With the present embodiment, particularly, upon receipt of a driver's viewing direction on a detected result obtained by the eye point camera 11 mounted on the own vehicle, a query is made as to whether the driver is viewing at an area facing a direction (in a lateral direction) different from a front direction of the vehicle for a time interval beyond, for instance, a fixed time. If the answer to this query is yes, then, a determination is made that the driver is willing to make a turn in the viewed direction.

Further, the presence or absence of the “indication of turning behavior” can be detected in a way described below. That is, recording means (such as ROM and RAM, etc.) is prepared to preliminarily record a pattern for a brake pedal to be depressed before a usual driver makes a turn at an intersection. Then, if the brake pedal is depressed, an operation is executed to detect the intention of the driver for making the turn depending on a query as to whether a current pattern for the brake pedal being depressed matches the preliminarily stored pattern. In this case, discrete patterns for individual drivers to depress the brake pedal before making the turn at the intersection are preliminarily recorded in the recording means to allow an operation to be executed to detect a particular driver during startup of an engine. This enables the “indication of turning behavior” to be detected with further increased precision.

Furthermore, the presence or absence of the “indication of turning behavior” can be detected not only by the technique of detecting the willing of the driver but also by another technique. That is, it may be determined such that there is the “indication of turning behavior” when, for instance, information, representing the own vehicle running on a right-turn-only lane or a left-turn-only lane, is acquired from either one of the navigation unit 14, the road-to-vehicle communication unit 15 and a front camera (not shown) for picking up an image of a road ahead of the vehicle. In another alternative, the existence of the “indication of turning behavior” may be determined when the own vehicle approaches an intersection scheduled to make a turn during the operation of the navigation unit 14 to make a navigational guide.

If there is the “indication of turning behavior” (S170: YES), then, the operation is routed to step S210 that will be described later. Moreover, if no “indication of turning behavior” is present, the series of operations subsequent to step S180 are executed to perform the normal swivel control.

During the execution of step S150, further, if the first swivel flag remains in the turn-on state (S150: YES), then, this represents a situation under which the operation has been already executed to move either one of the light axes of the headlights 20a and 20b to the turning-side maximum angle. Thus, an operation is routed to step S210 (described later) without detecting the “indication of turning behavior”.

Here, the operations executed at steps S180 to S200 (see FIG. 3) represent the normal swivel control in which the operation is executed such that a swivel angle θ is set to a value depending on a vehicle speed and a steering angle. More particularly, for the normal swivel control to be carried out, first, all of the flags (the first swivel flag, the second swivel flag, the first canceling flag, the second canceling flag and the light axis raising flag) are set to the turn-off states ((S180). Then, the operation is executed to acquire information on the vehicle speed from the vehicle speed sensor 12 (S190). Applying acquired information on the vehicle speed and the steering angle to the relational formula, established for the swivel angle θ (i.e., an angle of the light axis in the horizontal direction) to be determined with the vehicle speed and the steering angle, allows the swivel angle θ to be computed (S200).

Turning back to FIG. 2, at succeeding step S390, the operation is executed to compute the number of steps to be involved in control signals transmitted to the controllers 21a and 21b of the headlights 20a and 20b for the various motors 23a, 23b, 25a and 25b to be actuated. In executing such operation, the computed swivel angle θ nay be divided by a control angle per unit step.

Further, under a situation where the various motors 23a, 23b, 25a and 25b are not composed of the stepping motors, current orientations of the light axes may be detected to allow displacement values of the various motors 23a, 23b, 25a and 25b to be computed to values depending on such a current orientation, Next, control commands with information involving the number of steps related to such displacements are transmitted to the headlights 20a and 20b (S400), upon which the swivel control operation is terminated.

At succeeding step S210, next, a query is made as to whether the first canceling flag is placed in the turn-on state. If the first canceling flag is placed in the turn-on state (S210: YES), the swivel control for the intersection has been already completed and, hence, the swivel control operation is immediately terminated.

If the first canceling flag is placed in the turn-off state (S210: NO), then, a query is made again as to whether the first swivel flag is turned on (S220). If the first swivel flag remains in the turn-off state (S220. NO), then, at step S230 corresponding to first swiveling means, a turning-side headlight axis is set to the turning-side maximum angle. Further, the first swivel flag is set to the turn-on state (S240), after which the operation is routed to step S270 that will be described later.

On the contrary, in executing step S220, if the first swivel flag is turned off (S220), then, a query is made as to whether the second swivel flag is turned on (S250) (see FIG. 3). If the second swivel flag is turned off (S250: NO), then, a query is made as to whether the second swivel flag is turned on (S260).

If the second swivel flag is turned off (S260; NO), then, the operation goes to step S270. Here, a situation where the operation is routed to step S270 includes a state under which only the turning-side headlight axis is set to the turning-side maximum angle (representing a state under which only the light axis of the headlight on one side is moved to a turning-side). Therefore, in the operations at steps S270 to S290, a query is made as to whether the opposite-turning-side light axis needs to be moved to the turning direction. If the answer to this query is yes, then, the operation is executed to determine the relevant angle.

That is, during the execution of such an operation, first at step S270 corresponding to the second swiveling means, a query is made as to whether the own vehicle is in a turning condition. If the own vehicle is under the turning behavior (S270: YES), then, the opposite-to-turning-side headlight axis needs to be moved to the turning direction and, at step S280 corresponding to the second swiveling means, the opposite-to-turning-side headlight axis is set to the turning-side maximum angle. In addition, the second swivel flag is set to the turn-on state (S290), after which the operation goes to step S370 that will be described below.

At step S279, on the contrary, if the own vehicle is not turning (S270: NO), then, no need arises to move the opposite-to-turning-side headlight axis to the turning-side and the routine proceeds to step S370 that will be described below. In addition, in executing the operation at step S270 on the query as to whether the own vehicle is turning, a determination is made that the own vehicle is turning if the steering angle exceeds a predetermined threshold level (of, for instance, approximately 10 degrees) (with the same operation being executed at step S330).

Meanwhile, in executing step S260 (see FIG. 3), if the second swivel flag is turned on (S260: YES), then, this represents that both the light axes of the headlights 20a and 20b are set to the turning-side maximum angle. In this case, at step S300 corresponding to the second swivel canceling means, a query is made as to whether a steering-angle returning operation (representing a steering angle varied in a direction opposite to the turning-side beyond a certain angle based on a detected result of the steering angle sensor 13) is detected.

If no steering-angle returning operation is detected (S300: NO), then, the operation is routed to step S370 that will be described below. In contrast, if the steering-angle returning operation is detected (S300: YES), then, at step S310 corresponding to the second swivel canceling means, the opposite-to-turning-side headlight axis is set to a reference position (that is, a front area) in the horizontal direction and the second canceling flag is set to the turn-on state (S320), after which the operation is routed to step S370 that will be described below.

At subsequent step S250, if the second canceling flag is placed in the turn-on state (S250: YES), this represents a state under which the light axes of both the headlights 20a and 20b are set to the turning-side maximum angle once and, thereafter, only the opposite-to-turning-side headlight axis is returned to the reference position. In this case, a query is made as to whether the turning-side headlight axis needs to be returned to the reference position, upon which the operation is executed depending on a result on such determination.

More particularly, at step S330 corresponding to the first swivel canceling means, a query is made as to whether the own vehicle is turning. If the won vehicle is involved in the turning behavior (S330: YES), then, the swivel control operation is completed without causing the turning-side headlight axis to be returned to the reference position. In contrast, if the own vehicle is not turning (S330; NO), then, at step S340 corresponding to the first swivel canceling means, the turning-side headlight axis is set to the reference position in the horizontal direction. In addition, if the light axis raising flag is placed in a turn-on state, this flag is set to a turn-off state (S350) and the first canceling flag is set to the turn-on state (S360), upon which operations subsequent to step S390 are executed.

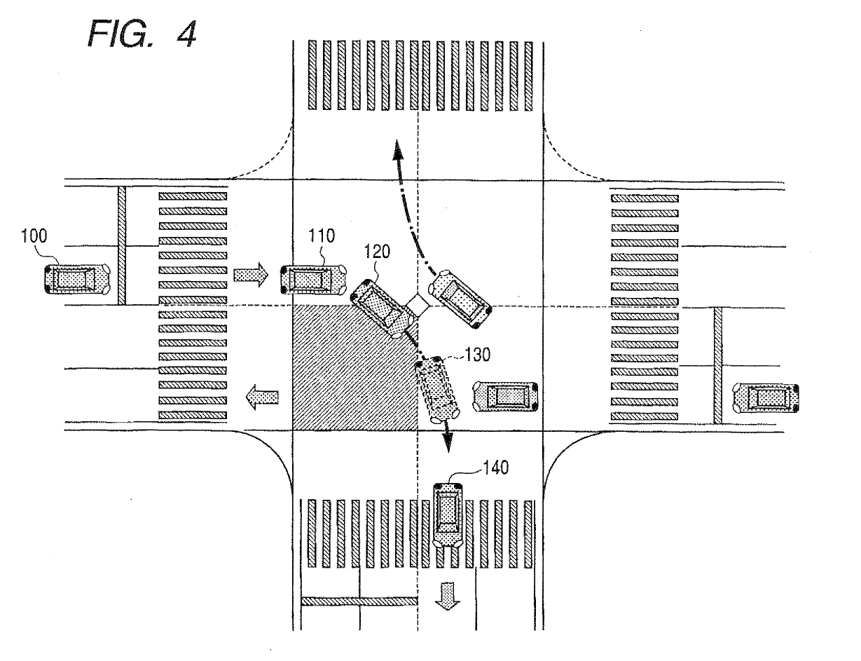

At step S370 corresponding to the light axis raising means, next, a query is made as to whether the own vehicle is located in a given region within an intersection. As used herein, the term “given region” refers to a right-side front region (indicated by a hatched area in FIG. 4) of the intersection, taking the form of a crossroads and divided into four segmented areas with two linear lines interconnected to centers of two roads, respectively, and connected to the intersection in opposition to each other, to which the own vehicle enters. Under a circumstance where the intersection takes the form of a T intersection, further, assumption is made that the intersection is the crossroad and the area inside the intersection may be divided into four regions in the same method as that mentioned above.

If the own vehicle is located in such a given region (S370: YES), then, at step S380 corresponding to the light axis raising means, the light axis raising flag is set to the turn-on state, thereby permitting operations subsequent to step S390 to be executed. Here, in executing the operation at S380, if the light axis raising flag is set to the turn-on state, the orientation of the light axis is set to face upward by a given angle (of, for instance, 0.5 degrees) with respect to an angle of the light axis directed in the vertical direction determined in the normal swivel control. In contrast, if the own vehicle is out of the given region (S330: NO), then, the operations subsequent to step S390 are immediately executed.

Next, description will be made of the location of the vehicle (on which the light control device 1 is installed) for carrying out such a swivel control operation and the orientation of the light axis of the headlight. FIG. 4 illustrates a situation with the own vehicle making a right turn.

First, when the own vehicle comes to the region in the intersection with the occurrence in which the indication of the turning behavior to make a right turn is detected (as indicated by a vehicle 100), only the light axis of the right headlight 20b is set to a right-side maximum swivel angle. When this takes place, the light axis of the left headlight 20a is set to the reference position (that is, in front of the vehicle) in the horizontal direction.

Thereafter, as the vehicle approaches the center of the intersection to take a steering angle corresponding to the turning behavior (like vehicle 110), the light axis of the left headlight 20a is also set to the right-side maximum swivel angle. Then, as the vehicle (as indicated by a vehicle 120) enters the given region R (indicated by a hatched area in FIG. 4), both the light axes of the headlights 20a and 20b are caused to vary upward by a vertically upward angle (of, for instance, 0.5 degrees).

As the vehicle begins to return the steering angle (like a vehicle 130), the light axis of the left headlight 20a is returned to the reference position in the horizontal direction. When the vehicle is steered at a steering angle deviated from the turning behavior (as achieved with a vehicle 140), the light axis of the right headlight 20b is returned to the reference position in the horizontal direction. When this takes place, the orientation of the light axis in the vertical direction is returned to a value depending on the normal swivel control.

[Operation and Advantage of the Present Embodiment]

With the light control device 1 of such a structure mentioned above, the computing section 10 executes the swivel control to acquire a detected result on the own vehicle approaching the intersection. Upon receipt of the indication of the turning behavior of the own vehicle, the computing section 10 allows the orientation of the light axis of the headlight, closer to the turning-side, to be shifted to the turn-on direction. During a phase in which the orientation of the light axis of the headlight, closer to the turning-side, is shifted to the turn-on direction, if the own vehicle takes a steering angle corresponding to the turning behavior, then, the computing section 10 allows the orientation of the opposite-turning-side light axis to be shifted to the turn-on direction.

With the light control device 1 implementing the present invention, the turning-side headlight axis is caused to illuminate the light to a front area of the vehicle on a direction predicted to make a turn before the own vehicle makes the turn at the intersection. This enables the driver of the own vehicle to easily recognize the existence or the nonexistence of a pedestrian or the like crossing the intersection before an attempt is made to make the turn.

Meanwhile, the opposite-turning-side headlight is caused to illuminate the light onto the area aligned in the turn-on direction at first after the beginning of the turning behavior. That is, the opposite-turning-side headlight illuminates the light onto an area in front of the own vehicle aligned in a traveling direction of the vehicle depending on the steering angle at all times.

With the light control device 1 of such a structure, accordingly, even if the maximum value of the swivel angle is set to an increasing value, the opposite-turning-side headlight illuminates the light onto the area in front of the own vehicle in the traveling direction of the vehicle. This enables the vehicle to maintain favorable visibility on a front area of the vehicle before the beginning of the turning behavior.

Under a circumstance where both the headlights 20a and 20b are set to the tuning-side maximum angle and the occurrence of the own vehicle with the steering angle shifted to a direction opposite to the turning direction is detected, the computing section 10 allows the orientation of the opposite-to-turning-side headlight axis to be shifted to the preset reference position in the direction opposite to the turning direction.

With the light control device 1 of such a structure, accordingly, as the steering angle of the own vehicle begins varying onto an area in a direction opposite to the turning direction, the orientation of the opposite-to-turning-side headlight axis is returned from the turning-side maximum angle to an area on a side opposite to the turning-side. This enables the opposite-turning-side headlight to illuminate the light onto the area in the running direction of the vehicle even during movement thereof when returning the steering angle. This enables the vehicle to favorably maintain increased visibility on the area in front of the vehicle even when returning the steering angle.

Further, when the orientation of the opposite-to-turning-side headlight axis is returned from the turning-side maximum angle to the area on the side opposite to the turning direction and, thereafter, the steering angle reaches an angle deviated from that representing the turning behavior, the orientation of the opposite-to-turning-side headlight axis are shifted to the predetermined reference position on the side opposite to the turning-side.

With the light control device 1 of such a structure, accordingly, when the turning behavior is finished, the orientations of the light axes of the headlights 20a and 20b can be reliably returned to the reference position.

Suppose that the intersection, into which the own vehicle enters, includes the crossroad and the intersection includes the four segmented areas, the four segmented areas are divided with the two linear lines interconnected to the centers of the two roads, respectively, and connected to the intersection in opposition to each other. Under such a situation, if the own vehicle enters the right-side front region among the four segmented areas of the intersection, the navigation unit 14 detects the occurrence of the own vehicle entering into the right-side front region. Upon receipt of a detected result on such an occurrence, the computing section 10 allows the orientations of the light axes of the headlights 20a and 20b to be moved upward.

With the light control device 1 of such a structure, accordingly, during the traveling of the own vehicle in movement making a right turn, if the own vehicle enters into the right-side front region, then, the orientations of the light axes of the headlights are moved upward. This enables the headlights to reliably illuminate the lights onto the pedestrian or the bicycle blocking the intersection. In addition, when own vehicle enters the right-side front region, the steering angle of the own vehicle takes the angle corresponding to the turning behavior and it is predicted that the orientations of the light axes of both the headlights 20a and 20b are moved to the turning-side maximum angle. Thus, even when attempting to move the orientations of the light axes upward, it is unlikely to dazzle an oncoming vehicle.

[Other Modified Forms]

The present invention is not limited to the embodiment set forth above and may be implemented in various modifications as described below.

With the present embodiment, although the headlights 20a and 20b are arranged to include the controllers 21a and 21b, respectively, the computing section 10 may take an arrangement to have functions of the controllers 21a and 21b in which the computing section 10 and the headlights 20a and 20b are directly connected through signal lines. With such a structure, both the controllers 21a and 21b may be omitted.

With the present embodiment set forth above, further, of the left and right headlights 20a and 20b, one headlight, having the light axis whose orientation is not set to the turning-side maximum angle, may be arranged to inhibit moving the orientation of the light axis upward. In this case, it becomes possible to reliably prevent the own vehicle from dazzling an oncoming vehicle.

Further, although the operation at step S310 (similar in the operation at S340) in the present embodiment is arranged to return the light axis of the headlight to the front position (at a fixed reference position), the light axis of the headlight may be returned to a position (reference position depending on the vehicle speed and the steering angle) depending on the vehicle speed and the steering angle. In this case, steps S190 and S200 may be executed on only the light axis of the headlight to be returned to the reference position in place of executing step S310.

While the present embodiment is arranged to set the orientation of the light axis at an angle directed upward when the own vehicle enters the right-hand front region, the own vehicle entering into the given region inside the intersection when making a turn at the intersection may be detected via either one of the navigation unit 14, the road-to-vehicle communication unit 15 and the front camera (not shown) for picking up an image of a forward road under which the orientation of the light axis is set to the angle directed upward.

While the specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention, which is to be given the full breadth of the following claims and all equivalents thereof.

What is claimed is:

1. A light control device installed on a vehicle and having a function to control orientations of light axes of headlights mounted on left and right areas of the vehicle in front thereof, the light control device comprising:
intersection detecting means for detecting if an own vehicle approaches an intersection of a road to provide a detected result;
intersection detected-result acquiring means for acquiring the result from the intersection detecting means;
steering angle detecting means for detecting a steering angle of the own vehicle to provide a detected result;
steering angle acquiring means for acquiring the result from the steering angle detecting means;
turning-behavior detecting means for detecting an indication of the own vehicle making a turn and a turning direction of the own vehicle regardless of the steering angle;
turning-behavior indication acquiring means for acquiring the result from the turning-behavior detecting means;
first swiveling means operative to allow an orientation of a turning-side headlight axis to be moved to the turning direction in response to the result of the intersection detected-result acquiring means, representing that the own vehicle approaches the intersection, and the result of turning-behavior indication acquiring means representing the indication of the own vehicle making the turn; and
second swiveling means operative to allow an orientation of an opposite-to-turning-side headlight axis to be moved to the turning direction when the result, delivered from the steering angle acquiring means, reaches a steering angle indicating turning behavior during operation of the first swiveling means.

2. The light control device according to claim 1, further comprising:
second swivel canceling means for canceling an operation of the second swiveling means and moving the orientation of the opposite-to-turning-side headlight axis to a predetermined reference position on a side opposite to the turning direction during the operation of the second swiveling means when the steering angle of the own vehicle, represented by the result acquired by the steering angle acquiring means, is changed to a direction opposite to the turning direction.

3. The light control device according to claim 1, further comprising:
first swivel canceling means for canceling an operation of the first swiveling means and moving the orientation of the turning-side headlight axis to a predetermined reference position on a side opposite to the turning direction after the second swiveling means is operated when the steering angle, represented by the result acquired by the steering angle acquiring means, reaches a steering angle nonequivalent to the turning behavior.

4. The light control device according to claim 1, further comprising:
intersection entrance detecting means for detecting the own vehicle entering into a given area of the intersection where the own vehicle runs only when making a turn at the intersection for thereby providing a detected result;
intersection entrance acquiring means for acquiring the result from the intersection entrance detecting means; and
light axis raising means for causing the orientations of the light axes of the headlights to move upward when detecting the occurrence of the own vehicle entering into the given area in response to the result delivered from the intersection entrance detecting means.

5. The light control device according to claim 1, wherein.
the intersection is located at a crossroad and divided into four regions with two linear lines passing through centers of roads connected to the crossroad; and
wherein the intersection entrance acquiring means detects the own vehicle entering into a front region, acting as the given region, of the four regions.
